(19) United States
(12) Patent Application Publication
(10) Pub. No.: US 2002/0078161 A1
(43) Pub. Date: Jun. 20, 2002

(54) UPnP enabling device for heterogeneous networks of slave devices

(75) Inventor: Doreen Yining Cheng, Los Altos, CA (US)

Correspondence Address: Michael E. Marion, Corporate Patent Counsel, U.S. Philips Corporation, 580 White Plains Road, Tarrytown, NY, 10591, US

(73) Assignee: PHILIPS ELECTRONICS NORTH AMERICA CORPORATION

(21) Appl. No.: 09/742,278

(22) Filed: Dec. 19, 2000

(51) Int. Cl. G06F 15/16

(52) U.S. Cl. 709/208; 709/246

(57) ABSTRACT

A bridging device couples an IP (Internet Protocol) network to one or more non-IP networks, in order to facilitate the control of non-UPnP (Universal Plug and Play) devices by a UPnP controller on the IP network. Each of the non-IP slave networks may employ different network technologies, such as USB, Bluetooth, HAVi, Home API, HomeRF, X-10, Jini, and so on. The bridging device includes an IP network interface for receiving commands and requests from the UPnP controller, and one or more slave network interfaces that transform the received commands and requests into device and network specific commands and requests. These device and network specific commands and requests are communicated to the controlled non-UPNP device, via the slave network, using the slave network's protocol. The bridging device also communicates event status messages to the UPnP controller, corresponding to the non-UPnP devices' response to the UPnP controller's commands and requests. The bridging device also includes enabling logic to support the UPNP addressing, discovery, and description processes for each of the devices on the non-IP network. To minimize the storage requirements at the bridging device, the bridging device is configure to use a file server that is also resident on an IP network, wherein the file server contains the detailed information required to effect the appropriate UPnP addressing, discovery, and description processes, and other information-laden tasks, as required.

### BACKGROUND OF THE INVENTION

1. Field of the Invention

This invention relates to the field of control systems, and in particular to the control of non-UPnP-compliant slave devices via a Universal Plug and Play (UPnP) object, or application.

2. Description of Related Art

“Universal Plug and Play (UPnP) is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. Universal Plug and Play is a distributed, open networking architecture that leverages TCP/IP and the Web technologies to enable seamless proximity networking in addition to control and data transfer among networked devices in the home, office, and public spaces.”¹ 1 “Universal Plug and Play Device Architecture”, Version 1.0, Jun. 8, 2000, © 1999-2000 Microsoft Corporation, incorporated by reference herein.

Other networking solutions are also available for control and data transfer among networked devices in the home, office, and public spaces. Standards continue to be developed which will allow devices of varying types and varying vendors to be controlled by a common controller. The HAVi architecture, the Home API initiative, the Universal Serial Bus (USB), HomeRF Lite, and the Bluetooth standard, each involving substantial contributions from Philips Electronics, the OSGI/Jini technology of Sun Microsystems, Inc., and others, have been developed to enhance the interoperability of multiple devices in a network.

Each of the available network solutions has particular advantages and disadvantages. The USB interface, for example, is relatively inexpensive, and, as such, is incorporated into many computer peripheral devices, such as keyboards, mice, pointing devices, and so on. The USB also provides a fairly high speed connectivity at this low cost, and has been adopted as a standard interface for video information transfer, such as from a video camera. The USB, however, has a limited cable length specification of less than 30 meters, and in some applications, less than 5 meters. The UPnP networking architecture, on the other hand, uses the TCP/IP protocol, which is currently used for world-wide communication networks, such as the world-wide-web. The TCP/IP, however, is a more capable, and hence more complex and costly protocol, which is typically embodied via a high speed Ethernet connection. Although TCP/IP is a viable networking solution for computers, high speed printers, servers, and the like, its inherent complexity does not encourage its use in consumer devices such as cameras, DVD players, recorders, and the like. In like manner, the Bluetooth standard supports the use of wireless devices in a networked environment, but is unsuitable for TCP/IP-based communications and control, such as provided by the UPnP standard.

The advantages and disadvantages of each networking solution are likely to result in a variety of networks being installed in a typical home or office environment. With the existence of multiple devices in a typical environment, there is an every increasing need for devices and systems that provide a bridge between and among such heterogeneous networks.

### BRIEF SUMMARY OF THE INVENTION

It is an object of this invention to provide a method and system for coupling IP networks with non-IP networks. It is a further object of this invention to provide a method and system that allows for the control of non-UPnP-compliant devices from a UPnP-compliant controller. It is a further object of this invention to enable the control of non-UPnP-compliant slave devices without modification to the slave devices.

These objects and others are achieved by providing a bridging device that couples an IP network to one or more non-IP networks. Each of the non-IP networks may employ different network technologies, such as USB, Bluetooth, IEEE 1394, Home API, HomeRF, Firefly, X-10, and so on. The bridging device includes an IP network interface for receiving commands and requests from a UPnP controller on an IP network, and one or more slave network interfaces that transform the received commands and requests into device and network specific commands and requests. These device and network specific commands and requests are communicated to the controlled device, via the slave network, using the slave network's protocol. The bridging device also communicates event status messages to the UPnP controller, corresponding to the non-UPnP devices' response to the UPnP controller's commands and requests. The bridging device also includes enabling logic to support the UPnP addressing, discovery, and description processes for each of the devices on the non-IP network. To minimize the storage requirements at the bridging device, the bridging device is configured to use a file server that is also resident on the IP network, wherein the file server contains the detailed information required to effect the appropriate UPnP addressing, discovery, and description processes, and other information-laden tasks, as required.

### BRIEF DESCRIPTION OF THE DRAWINGS

The invention is explained in further detail, and by way of example, with reference to the accompanying drawings wherein:

FIG. 1 illustrates an example block diagram of a system comprising a UPnP enabling device that bridges a UPnP control device to multiple non-UPnP devices in accordance with this invention.

FIG. 2 illustrates an example block diagram of a UPnP enabling device for bridging a UPnP controller to non-IP networks, in accordance with this invention.

FIG. 3 illustrates an example prior art UPnP protocol stack.

FIG. 4 illustrates an example prior art UPnP process.

FIG. 5 illustrates a more detailed example block diagram of functions performed by a UPnP enabling device in accordance with this invention.

FIG. 6 illustrates an example flow diagram of thread creation to provide a non-blocking architecture for communications between the UPnP controllers and the non-UPnP devices, in accordance with this invention.

Throughout the drawings, the same reference numerals indicate similar or corresponding features or functions.

### DETAILED DESCRIPTION OF THE INVENTION

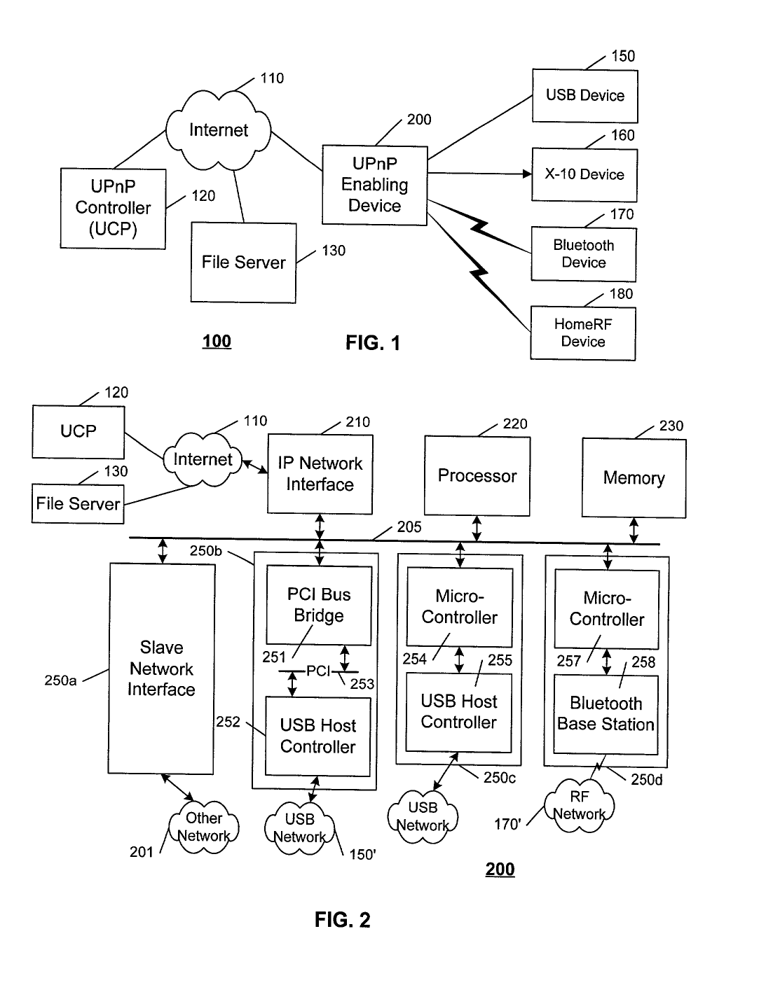

FIG. 1 illustrates an example block diagram of a system 100 comprising a UPnP enabling device 200 that bridges a UPnP controller, or UPnP User Control Point (UCP) 120 to multiple non-UPnP-compliant devices 150-180 in accordance with this invention. For ease of reference, UPnP-compliant objects are referred to as UPnP objects, and devices that are not UPnP-compliant are referred to as non-UPnP devices. These non-UPnP devices include, for example, devices on a USB network, a bluetooth network, a HAVi-compatible network, such as an IEEE 1394 network, a Home API network, a HomeRF network, a Firefly network, a power line network, such as an X-10 network, and a Jini-compatible network.

The UPnP enabling device 200, in conjunction with a file server 130, provides the interface required to effect the control of the non-UPnP devices by the UPnP user control point 120, by emulating each of the non-UPnP devices as a UPnP-compliant device. In operation, the UPnP user control point 120 is a conventional UPnP controller that is configured to operate in conformance with the UPnP standards and protocols, issuing commands and requests to, and receiving status reports from, UPnP-compliant devices. In like manner, the non-UPnP devices 150-180 are conventional non-UPnP devices, such as USB-compliant devices 150, X-10-compliant devices 160, Bluetooth-compliant devices 170, and others 180, that are configured to receive commands from, and send status reports to, controllers that are specific to each of these non-UPnP standards and protocols. The UPnP enabling device 200 provides the bridging interface required to effectively emulate each non-UPnP device as a UPnP-controllable device for control by the UPnP user control point, and to emulate the UPnP user control point as a non-UPnP controller that conforms to each of the standards and protocols of the non-UPnP devices 150-180.

Depending upon packaging and marketing requirements, a UPnP enabling device 200 in accordance with this invention may include support for one or more non-UPnP interfaces. For example, a USB-specific enabling device 200 may be marketed that includes the UPnP interface for communication with the UPnP user control point, and a USB port, or pair of USB ports, for communication with USB devices on a USB network. Alternatively, an embodiment of the UPnP enabling device 200 of this invention may include multiple interface options, such as a pair of USB ports, plus an RF transceiver for communicating with a device on a Bluetooth network. Also, although most controllable devices are configured to operate in a multiple-device network, the UPnP enabling device 200 may also be configured to provide an interface for devices that operate via point-to-point control, such as an infrared interface to a printer or to a television receiver. The invention is presented herein using the paradigm of a UPnP enabling device for multiple-heterogeneous-networks, for illustrative purposes, although various alternative configurations will be obvious to one of ordinary skill in the art in view of this disclosure.

FIG. 2 illustrates an example block diagram of a UPnP enabling device 200 for bridging a UPnP user control point 120 to non-IP networks 150′, 170′, 201, in accordance with this invention. Four example non-UPnP interfaces 250a-d, commonly referred to hereinafter as slave network interfaces, are included in the example enabling device 200 of FIG. 2. Any of a variety of techniques can be used to provide these interfaces 250a-d. Illustrated in the interface 250b, for example, a PCI bus 253 is used as an intermediate bus between an internal bus 205 of the enabling device 200 and a USB network 150′. In this manner, a conventional PCI-to-USB host controller 252 can be used to provide a USB-compliant interface to the USB network 150′. In this example interface 250b, a PCI bus bridge 251 transforms data on the internal bus 205 into PCI-compliant signals, and vice-versa, for communication via the PCI bus 253. Alternatively, as illustrated by the slave interface 250c, a microcontroller 254 may be provided that transforms the data to and from the internal bus 205 from and to a USB host controller 255 directly. In like manner, a microcontroller 257 is used in the slave interface 250d to communicate information to and from the internal bus 205, from and to a Bluetooth base station 258, for wireless communication with Bluetooth-compliant devices via an RF network 170′. Techniques for transforming data to and from an internal bus 205 and an external network 150′, 170′, 201, are common in the art.

In a preferred embodiment of this invention, a processor 220 receives information from a UPnP user control point (UCP) 120 via an IP network interface device 210 and the internal bus 205. The interface device 210 includes Ethernet, xDSL, cable modem, wireless local loop, satellite, fiber to curb, or other IP network structure. The processor 220 transforms the UPnP information from the UCP into network and device specific commands, and communicates these network and device specific commands, as required, via the internal bus 205, to the appropriate slave interface device 250a-d for communication to the particular non-UPnP device being controlled. In like manner, the processor receives information from each non-UPnP device, or from a network controller of the non-IP network, via the slave interface device 250a-d, transforms the information into UPnP messages, as required, and communicates these UPnP messages to the UCP 120. Other embodiments will be evident to one of ordinary skill in the art. For example, in a USB-specific embodiment, the processor 220 may communicate directly with the IP network interface 210 for communicating UPnP messages, and directly with a USB host controller 255 for communicating USB messages, without the need for an intermediate bus structure 205.

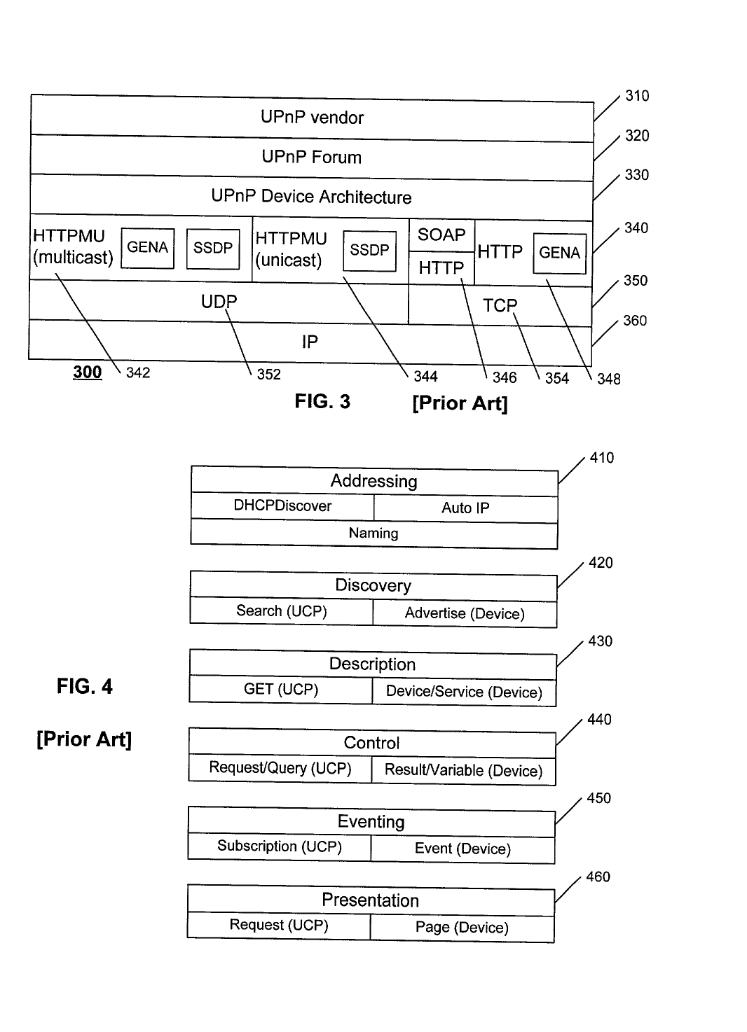

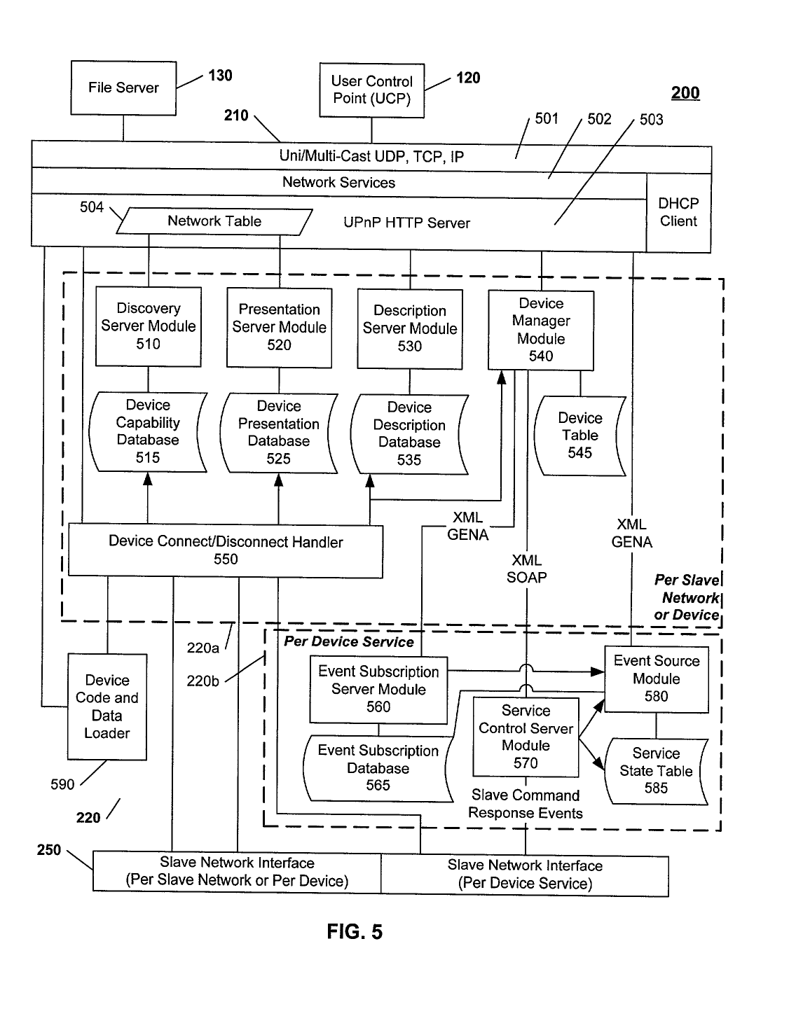

The specific functions performed by the processor 220 to support UPnP messaging are discussed further below with regard to FIG. 5. FIGS. 3 and 4 are presented to provide a context for the understanding of the functions presented in FIG. 5.

The UPnP Device Architecture defines the protocols for communication between UPnP user control points (UCPs) and devices. FIG. 3 illustrates the UPnP protocol stack 300 that is used for the discovery, description, control, eventing, and presentation phases of UPnP network management. At the highest layer 310, messages contain only UPnP vendor-specific information about their devices. Moving down the stack, vendor content 310 is supplemented by information 320 defined by UPnP Forum working committees. Messages from the layers 310, 320 above are hosted in UPnP-specific protocols 330, defined by the UPnP architecture. These protocols 330 are formatted using the Simple Service Discovery Protocol (SSDP), General Event Notification Architecture (GENA), and Simple Object Access Protocol (SOAP), and delivered via HTTP, at level 340. The HTTP 340 is either multicast 342 or unicast 344 running over UDP 352, or standard HTTP 346, 348 running over TCP 354. Each UDP 352 or TCP 354 message, at protocol level 350, is delivered via IP 360.

FIG. 4 illustrates an example UPnP process for establishing and maintaining a network of UPnP user control points and controlled devices. The foundation for UPnP networking is IP addressing. Each device is assigned a unique address, at 410, either via an assignment by a Dynamic Host Configuration Protocol (DHCP) server that is managing the network, or via an Auto IP address generation function, if the network is not managed. Devices may also be assigned a device name, for ease of subsequent references to each device.

Given an IP address, the next step in the UPnP process is discovery 420, wherein each device provides the network with a few essential specifics about the device or its services, with a pointer to more detailed information, as required. The UCPs may also use the discovery process to search for devices of particular interest. The devices advertise their essential characteristics when they first enter the network, as well as in response to a search for their characteristics by a UCP. To assure that the network is kept up to date, devices are required to periodically refresh their advertisement via the discovery process 420. Devices are logged off the network when they communicate a logoff message, or when they fail to refresh their advertisement.

The next step in the UPnP process is description 430, wherein UCPs that are interested in advertised devices issue a request for additional information from a URL (Universal Resource Locator) address that is contained in the device advertisement. Typically, this additional information regarding the device and its services is located at the device, but it may also be located at a remote location, such as an Internet site that is maintained by the vendor of the device.

When a UPnP UCP learns of a device's capabilities, it is able to control and/or monitor the device, at 440, via an action request or a value query. In response to the action request, the device effects the action, and reports a result. Generally, the result is an acknowledgement that the requested action was effected, but it may be a more detailed message that reports the current device state, and/or the state of one or more variables associated with the device. In response to a value query, the device reports the state of one or more variables identified in the value query.

The UCP may also request notification whenever an event occurs at the device, via the eventing process 450. The UCP ‘subscribes’ to be notified of any change of state at the device, and may exclude specified state changes, such as the change of value of particular variables, from this notification process. Whenever a device changes state, it notifies all subscribers of the event, except those subscribers that have excluded the specific state change from their subscription.

The UCP presents the capabilities and controls associated with a device, based on a presentation page that is provided by the device, at 460. The UCP requests the presentation page from a URL that is provided in the device description. As with the device description at 430, the URL may address the device, or it may address a remote site, such as the vendor's Internet site, or a third-party service provider's site.

FIG. 5 illustrates an example block diagram of a UPnP enabling device 200 comprising a UPnP interface 210, a UPnP proxy enabling processor 220 (220a and 220b), and an interface 250 to a non-IP network in accordance with this invention.

The UPnP (IP network) interface 210 includes an IP network module 501, and a network services layer 502 for accessing the IP network module 501, including creating and managing network communications, formatting appropriate IP messages, and receiving and sending messages. Consistent with conventional practice, the network services layer 502 sends multicast UDP messages multiple times, to enhance reliability.

The UPnP HTTP server 503 is a server process that supports the HyperText Transfer Protocol (HTTP) used for communication between the UPnP user control points (UCPs) 120 and the controlled devices (150-180 in FIG. 1), as discussed above with regard to the HTTP protocol layer 340 of FIG. 3. In a preferred embodiment, the HTTP server 503 handles interactions between multiple UCPs 120 and multiple devices, and is configured to provide a non-blocking transfer. This non-blocking transfer is easily effected via the use of threads to handle different types of requests, as discussed further below. The functions provided by a HTTP server 503 in a preferred embodiment include:

creating and managing threads to handle device connect and disconnect, and to handle UPnP defined queries for device capability, description, and presentation;

creating and maintaining a network table 504 that keeps track of each network and the type of threads created for the network, and records the communication data structures for each thread;

monitoring a pre-defined TCP/IP server port and a pre-defined multicast UDP port to receive HTTP messages and to pass them to the corresponding modules that are responsible for the messages; and

providing the Application Program Interface (API) for transforming responses and GENA notifications into proper HTTP messages, and invokes network services 502 to send the messages.

The UPnP HTTP server 503 uses the network table 504 and the value of the HTTP request line, such as the HTTP requests GET, POST, M-POST, M-SEARCH, SUBSCRIBE, and UNSUBSCRIBE for dispatching. For example, upon receipt of an HTTP M-SEARCH request, it dispatches messages to the discover server modules 510 corresponding to each network in the UPnP enabling device 200, to effect the requested search.

In a preferred embodiment of the UPnP enabling device 200, the processor 220 includes two parts for interfacing with the UPnP interface 210. A first part 220a includes components that are embodied for each slave network or each device, and a second part 220b includes components that are embodied for each service provided by each slave device in each slave network. For example, a VCR device typically provides a variety of services, including a clock service, a tuner service, and a tape transport service.

The network-level processing block 220a includes the modules 510, 520, 530 required to effect and coordinate the UPnP discovery, presentation, and description phases, respectively, as well as a device manager module 540 that effects and coordinates commands and messages related to each device in the slave network. A device connect/disconnect handler 550 provides information to the appropriate databases 515, 525, 535 that the modules 510, 520, 530 use to respond to UPnP requests regarding the presence of devices on the network, and their capabilities. In a preferred embodiment, the device connect/disconnect handler 550 provides the following functions:

determining the devices connected to the associated slave network;

loading the code and data required for each connected device; and

providing device-dependent data and code to the modules 510-530, via the databases 515-535. In general, the device-dependent data and code is provided via access to a file server 130, discussed further below.

When activated, the device connect/disconnect handler 550 uses the slave network interface 250 to determine the identity of each device in its associated network. In accordance with one aspect of this invention, a file server 130 is accessible via the IP network interface 210. This file server 130 is configured to contain the detailed information required to effect the UPnP notification, coordination, and control functions for each identified device, as well as the mapping between the advertised UPnP commands and the corresponding device and network specific commands. Depending upon the available memory (230 in FIG. 2) at the UPnP enabling device 200, the processor 220 fills in the discovery, presentation, and description information at the databases 515, 525, 535, respectively. Alternatively, the processor 220 merely stores the appropriate URLs of each device's presentation and description information, for subsequent communication to the UCP 120, as required, and as discussed above. These URLs may address information on the file server 130, or at other accessible locations, such as a vendor-supported, or third-party provided, Internet site.

The device connect/disconnect handler 550 accesses this information from the file server 130 via a device code and data loader 590 that is configured to form the appropriate IP-compatible requests, and to receive the corresponding IP responses. The particular functions that the device code and data loader 590 provide depend upon the distribution of information storage between the UPnP enabling device 200 and the file server 130, and includes some or all of the following functions:

constructing the local path of the URL associated with each device's code and data, based on the IP address or host name of the file server 130;

providing the interface to the device connect/disconnect handler 550 to facilitate sending notifications regarding the need to access the code or data associated with a particular device;

forming the HTTP/GET message to fetch the required code or data for the device, via the UPnP HTTP server 503;

receiving the results of the HTTP/GET message from the UPnP HTTP server 503; and

returning the results to the device connect/disconnect handler 550.

If the UPnP enabling device 200 allows for dynamically loaded code to support the slave device or network interface, the code and data loader 590 also separates the code and data, communicates the data to the device connect/disconnect handler 550, processes the code, and stores it to a memory address assigned for dynamic linking. In a preferred embodiment, to conserve memory space (230 in FIG. 2) at the device 200, the file server 130 contains the binary code for each process that is potentially required at the device 200. This code is preferably stored and communicated as an attachment to an HTML page that is associated with the particular device and/or function.

In a preferred embodiment, after creating and starting one device connect/disconnect handler 550 for each slave network, the HTTP server 231 is placed in a wait state during initialization until at least one of the handlers have finished adding the required information to the corresponding databases. After initialization, the handler 550 monitors each device for connection and disconnection, and updates each database 515, 525, 535 by appropriately adding or deleting device information. The handler 550 also forms one or more GENA notification messages, and invokes the API of the HTTP server 503 to multicast such additions and deletions. The handler 550 also periodically forms an SSDP ‘alive’ message, and invokes the API of the HTTP server 503 to broadcast the message, thereby refreshing each device's active status on the IP network.

The discovery server module 510, and corresponding device capability database 515, implement the UPnP discovery server specification. As noted above, in a preferred embodiment, the discovery module 510 is responsible for providing the UPnP discovery function for each device within its corresponding network. The functions of the discover module 510 in a preferred embodiment include:

providing an API for querying the network or devices for device characteristics;

processing UPnP search messages, such as an M-SEARCH message with an “ssdp:discover” message header; and

upon receipt of an SSDP query, searching the device capability database 515, forming a response, and invoking the aforementioned HTTP server 503 API to return the response to the requester.

The device capability database 515 contains data structures in memory that store information about the capabilities of each device known to the module 510, and is preferably organized for efficient operations for SSDP searches.

The description server module 530 implements the UPnP description server specification, discussed above. The module 530 either provides the appropriate URL for locating the device description and/or the presentation, or it provides the device description and/or the presentation, directly or via the file server 130, for devices that do not have a corresponding remote URL address at which the description and/or the presentation is located. Initially, it will be expected that devices on a non-IP network will not have an associated UPnP description at a remote URL address, and thus the UPnP enabling device 200 will need to provide the description, via a device description database 535, or via access to the file server 130. As this invention becomes commonplace, however, vendors or third party developers are likely to develop UPnP descriptions for non-UPnP devices, and the amount of information required to be stored at the device description database 535, or at the file server 130 will, correspondingly, be substantially reduced. The functions of the description server module 530 include:

providing an API for querying device descriptions;

processes HTTP/GET messages addressed to the local description server that is responsible for presenting the description for the devices on the slave network under its responsibility; and

searching the device description database 535 in response to HTTP/GET messages, and invoking the API at the HTTP server 503 to return the response.

The presentation module 520 implements the UPnP presentation server specification, and is configured similar to the description server module 530 to respond to HTTP/GET messages addressed to the local presentation server responsible for the devices on the network, using the device presentation database 525, or the file server 130 as required.

In a preferred embodiment, the device manager module 540 enables multiple UCPs 120 to simultaneously control multiple devices in the slave network under its responsibility, in response to device access and control requests, such as HTTP POST and M-POST messages. The functions of the device manager module include:

creating and managing threads to route and handle device control requests, as discussed below; and

providing an interface for the device connect/disconnect handler to provide notification of device connect and disconnect events.

The device table 545 stores the mapping between a service identification (for example, a device UUID and a service name) and the data structures used to communicate data with the service control server 570 and the event subscription server 560.

The service-level UPnP block 220b includes an event subscription server module 560, a service control server module 570, and an event source module 580. Typically, a device provides one or more services. Preferably, there is one event subscription server module 560, one service control server module 570, and one event source module 580 associated with each service provided by a device. Correspondingly, there is one event subscription database 565 and one service state table 585 associated with each service.

The service control server module 570 is responsible for effecting control commands directed to its associated service. The functions of the service control server module 570 in a preferred embodiment includes:

parsing SOAP commands, invoking the appropriate driver interface(s) to effect each command, and invoking the API at the HTTP server 503 to send an acknowledgement or failure message to the requester;

updating the service state table 585 upon successful command execution, if the state of the service changes;

monitoring events posted by the slave device, and updating the service state table 585 if the state of the service changes; and

invoking the event source module 580 with each update of the service state table 585.

In a preferred embodiment, because not all slave device drivers are configured to report the entire state of the driven device, the service state table 585 is used to record the current value of the state of each service (power, register values, and so on). The table 585 is initialized when the device enters the UPnP control network and is kept consistent with the state of the service(s) provided by the device by updating the state every time a state-changing command is successfully executed.

The event subscription server module 560 is responsible for allowing UCPs to express their interest about device events related to each service. The functions of the event subscription server module 570 in a preferred embodiment includes:

parsing GENA event subscription messages, entering the subscribing UCP's identification and subscribed events in the event subscription database 565, or at the file server 130, and invoking the API of the HTTP server 503 to send an acknowledgement (or failure notification) to the subscriber UPnP controller; and

invoking the event source module 580 to pass the current state of the service to a first-time subscriber UCP.

The event source module 580 is responsible for posting events of the service to all UCPs that have subscribed to such events. The functions of the event source module 580 in a preferred embodiment includes:

providing an interface for the service control module 570 to pass notifications about the changes in the service status to the service state table 585;

examining the event subscription database 565, or the corresponding data on the file server 130, notifying subscriber UCPs of subscribed event changes by forming a GENA notification message, and invoking the API of the HTTP server 503 to send the GENA message; and

providing an interface for the event subscription server module 560 to effect the notification of each first-time subscriber of the state of the service, via the formation and transmission of a GENA notification message, via the API of the HTTP server 503.

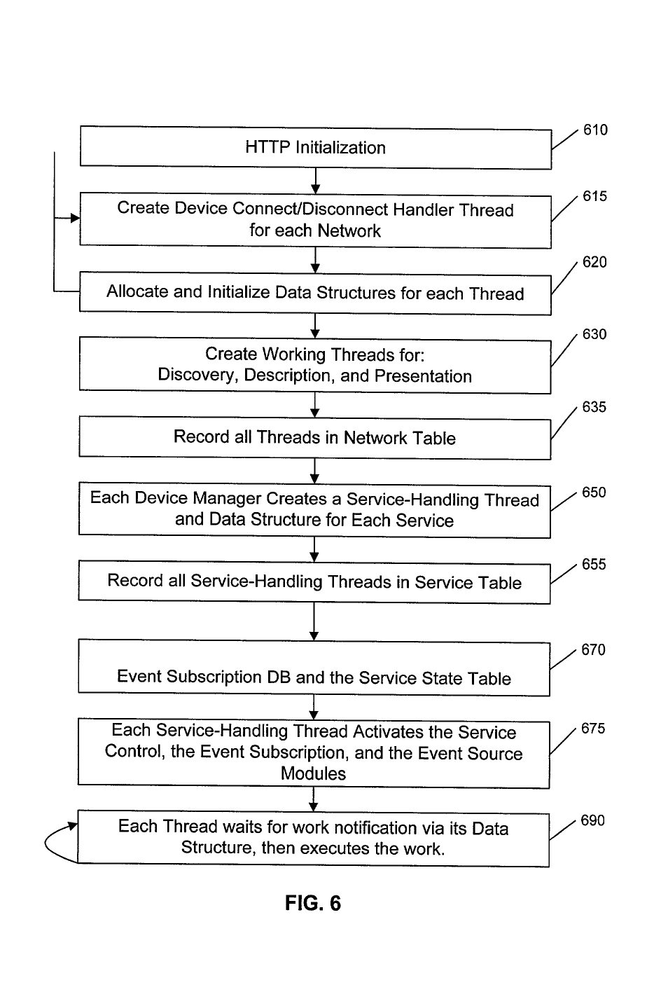

FIG. 6 illustrates an example flow diagram of thread creation to provide a non-blocking architecture for communications between the UCPs and the slave devices, in accordance with this invention. For convenience and ease of understanding, the foregoing description provides references to items in the previous figures, although the principles presented in this flow diagram are also applicable to other structures or system configurations. The first digit of each reference numeral corresponds to the first figure at which the referenced item is introduced.

At 610, the HTTP server 503 allocates and initializes memory spaces for the network table 504, the device capability database 515, the device description database 535, and the device presentation database 525, for each slave network. As noted above, this initialization information may include references to information that is stored at the file server 130, or at remote URLs. The HTTP server 503 also allocates and initializes a space for communication and synchronization between itself and each of the slave network's device connect/disconnect handler 550. At 615, the HTTP server 503 creates a device connect/disconnect handler thread for each network, and waits until at least one of the device connect/disconnect handlers 550 reports that it has successfully initialized the device capability database 515, the device description database 535, and the device presentation database 525. When the HTTP server 503 receives the notification that the device connect/disconnect handler 550 has initialized the databases 515, 525, 535, the HTTP server 503 allocates and initializes a data structure for each working thread that it will create, at 620. These data structures are used to communicate with the threads. The HTTP server 503 repeats the process 615-620 for each network, as each network's device connect/disconnect handler 550 reports a successful initialization of the network's databases 515, 525, 535. At 630, the HTTP server 503 creates working threads, one for handling device discovery, one for handling device description, and one for handling device presentation. Each thread activates the corresponding modules and receives a pointer to the database 515, 535, and 525, respectively, that it will use. At 635, the HTTP server 503 records each network type, each thread type, and the communication data structure for each thread, into the network table 504. Thereafter, the HTTP server 503 directs each device manager 540 to set up service handling threads for each device in the network for which the manager 540 is responsible. The manager 540 executes in the context of the HTTP server 231.

At 650, each device manager 540 first queries the discovery service module 510 to obtain a list of devices in the network for which it is responsible. For each device, the manager further queries the description server module to get a list of services provided by the device. The manager 540 then creates a service-handling thread for each service provided by each device, and a corresponding data structure for communicating with each thread. At 655, the device manager 540 records the mapping of each thread to each service provided by the device in the device table 545.

At 670, each service-handler thread allocates and initializes the event subscription database 565 and the service state table 585 for its associated service. At 675, each service-handler thread activates each of the service control 570, event subscription 560, and event source 580 modules associated with the service.

Not illustrated, when a device is added to the network, the device manager 540 creates and records a service-handler thread for each service provided by the device, as in blocks 650-655. The newly created service-handler thread creates and initializes the service-specific database 565 and table 585, and activates the modules 560, 570, 580, as in blocks 670-675, above.

At 690, all threads created in blocks 630 and 650 wait until being notified of pending work, via the data structure associated with each thread. When the HTTP server 503 identifies an incoming request for a particular working thread, the server 503 places the request into the data structure corresponding to the thread, then returns to handle the next request. In this manner, the HTTP server 503 devotes substantially little time to the processing of request; the actual processing of each request is effected via a single placement of the request into an appropriate data structure. In a preferred embodiment, each thread periodically checks the contents of its data structure. When one or more items of the data structure change, the thread determines the appropriate action to take in response to the change, and reacts accordingly. After the work is completed, the thread invokes the API at the HTTP server 503 to communicate an acknowledgement (or a failure notice if the request was not fulfilled) to the UCP that issued the incoming request. In the case of an incoming control command, the command is placed in communication data structure of the service-handling thread of the targeted service. When the service-handling thread detects this command in its data structure, it determines the type of command. If the command is an event subscription, it passes the command to the event description server module 560. If the command is a service control command, the command is passed to the service control server module 570.

Alternative thread initiation and control schemes will be readily apparent to one of ordinary skill in the art. For example, a thread can be created when a request for a particular service arrives for the first time. In this scheme, for example, the device manager 540 provides an interface for the device description server module 530 to pass a notification when a description is requested by a UCP. Upon receiving the notification, the device manager 540 checks the device table 545 to determine if the service-handling thread already exists for the device; if not, a thread is created for each service provided by the device. In this manner, service-handling threads are only created for devices for which at least one UCP has expressed interest. Alternatively, although threads may be expected to provide an efficient implementation, processes can be used to implement the enabling logic in lieu of threads. Such processes will communicate either via shared memory, as in the case of threads, or via message passing.

As presented above, an embodiment of this invention provides a means for facilitating the control of non-UPnP devices via a UCP. As will be evident to one of ordinary art, if, as in the examples provided, shared memory is used for communication and synchronization, proper locking mechanisms, common in the art, should be used to ensure proper operation. It is important, for example, for the device capability database 515, the device description database 535, the device presentation database 525, and the device table 545 to be consistent, and therefore atomic operations for updating each database should be enforced. For example, write operations to a database or table will typically take priority over read operations, to assure that the read operation is provided the freshest data. These and other means of maintaining data consistency are common in the art.

In a preferred embodiment of this invention, the use of a consistent naming convention scheme is used to simplify the design. For example, the local part of the URL that is used for each server has the prefix: network_type/server_type, such as “usb/descriptionServer”, or “bluetooth/presentationServer”, and so on. To facilitate locating of device files at the file server 130 by the device connect/disconnect handler 550, each file name contains an identifier of the device, and the contents of the file, such as “USB interface.code”, “laser_printer.description”, or “scanner.capability”. These names may be made more specific by including, for example, an indication of the make or model of the device. If device functions are provided via library functions, the function names contain a prefix that uniquely identifies the device, thereby avoiding function names conflicts.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the particular functional partitioning presented in the figures is presented for illustrative purposes, and various combinations of hardware and software implementations may be used to embody the invention. These and other system configuration and optimization features will be evident to one of ordinary skill in the art in view of this disclosure, and are included within the scope of the following claims.

I claim:

1. A UPnP interface device that is configured to facilitate UPnP control of at least one non-UPnP device that are located on one or more slave networks using one or more different network technologies, comprising:
an IP interface to at least one UPnP controller, the UPnP controller being configured to issue a UPnP command in conformance with a UPnP protocol,
at least one non-IP interface to the at least one non-UPnP device, and
a processor that is configured to:
receive the UPnP command, via the IP interface,
transform the UPnP command into a device command,
communicate the device command to a target device of the at least one non-UPnP device via the at least one non-IP interface, and
communicate a UPnP acknowledgement of the UPnP command to the at least one UPnP controller, via the IP interface, and

2. The device of claim 1, wherein the one or more network technologies include at least one of: a USB network, a bluetooth network, a HAVi-compatible network, an IEEE 1394 network, a Home API network, a HomeRF network, a Firefly network, a power line network, an X-10 network, and a Jini-compatible network.

3. The device of claim 1, wherein:
the UPnP controller is further configured to issue a UPnP request in conformance with the UPnP protocol,
the UPnP request includes one of: a description request, a presentation request, a subscription request, and a query, and
the processor is configured to provide at least one of: a device description, a service description, a presentation page, an event, and a value of a variable, in response to the UPnP request.

4. The device of claim 3, wherein
the IP interface also provides access to a file server, and
the processor provides the at least one of: the device description, a service description, a presentation page, an event, and a value of a variable, based on information received from the file server.

5. The device of claim 1, wherein
the processor includes at least one of:
a discovery module that is configured to provide an advertisement of the at least one non-UPnP device to the UPnP controller,
a description module that is configured to provide a description of functions of the at least one non-UPnP device to the UPnP controller, in response to a request from the UPnP controller, and
a presentation module that is configured to provide a presentation page that facilitates a control of the at least one non-UPnP device by a user.

6. The device of claim 5, wherein
at least one of the discovery module, the description module, and the presentation module is configured to provide the advertisement, the description, and the presentation page, respectively, for the at least one non-UPnP device of the slave networks.

7. The device of claim 1, wherein
the processor includes at least one of:
a service control module that communicates commands to the target device,
an event subscription module that receives requests from the at least one UPnP controller to be notified of one or more changes of state of the target device, and
an event source module that notifies the at least one UPnP controller of one or more changes of state of the target device.

8. The device of claim 7, wherein
the service control module maintains a service state table that reflects the state of the target device, and
the event source module notifies the at least one UPnP controller of the one or more changes of the state of the target device based on the service state table.

9. The device of claim 1, wherein the UPnP server enabler communicates the device command to the target command by modifying a data structure that is associated with a thread, and the thread effects the communication to the at least one non-UPnP device of the slave networks.

10. The device of claim 1, wherein
the IP interface also provides access to a file server, and
the processor effects the transform of the UPnP command into the device commands based on information received from the file server.

11. The device of claim 1, wherein
the processor is further configured to recognize a connection and disconnection of the at least one non-UPnP device, and initiates and terminates threads in response to each connection and disconnection, respectively.

12. A method for facilitating UPnP control of at least one non-UPnP device on a slave network, comprising:
receiving device-dependent data corresponding to each of the at least one non-UPnP device from a file server,
receiving a UPnP command in conformance with a UPnP protocol from a UPnP controller,
transforming the UPnP command into a device command, based on the device-dependent data received from the file server,
communicating the device command to a target device of the at least one non-UPnP device on the slave network, and
communicating a UPnP acknowledgement of the UPnP command to the UPnP controller.

13. The method of claim 12, wherein the slave network is one of: a USB network, a bluetooth network, a HAVi-compatible network, an IEEE 1394 network, a Home API network, a HomeRF network, a Firefly network, a power line network, an X-10 network, and a Jini-compatible network.

14. The method of claim 12, further including:
receiving a UPnP request in conformance with the UPnP protocol,
the UPnP request including one of: a description request, a presentation request, a subscription request, and a query, and
providing at least one of: a device description, a service description, a presentation page, an event, and a value of a variable, in response to the UPnP request, based on information received from the file server.

15. The method of claim 12, further including at least one of:
providing an advertisement of at least one non-UPnP device to the UPnP controller,
providing a description of functions of the at least one non-UPnP device to the UPnP controller, in response to a request from the UPnP controller, and
providing a presentation page that facilitates a control of the at least one non-UPnP device by a user.

16. The method of claim 15, wherein
at least one of the advertisement, the description, and the presentation page are provided by the file server.

17. The method of claim 12, further including
receiving requests from the UPnP controller to be notified of one or more changes of state of the at least one non-UPnP device, and
notifying the UPnP controller of one or more changes of state of the at least one non-UPnP device.

18. The method of claim 17, further including
maintaining a service state table that reflects the state of the target device, and
notifying the UPnP controller of the one or more changes of the state of the at least one non-UPnP device based on the service state table.

19. The method of claim 12, further including
creating a thread that is associated with the at least one non-UPnP device of the slave network, and
modifying a data structure that is associated with the thread; and
wherein the thread is configured to effect the communication of the device command to the at least one non-UPnP device of the slave network, based on the modification of the data structure.

20. A network comprising:
an IP sub-network,
a non-IP sub-network, and
a UPnP enabling device that facilitates control of a device on the non-IP sub-network by a UPnP controller on the IP sub-network.

21. The network of claim 20, further including
a file server on the IP sub-network, and
wherein
the UPnP enabling device facilitates the control of the device based on information received from the file server.

22. The network of claim 20, wherein
the UPnP enabling device is configured to:
receive a UPnP command from the UPnP controller on the IP network,
transform the UPnP command into a device command, and
communicating the device command to the device on the non-IP sub-network.

23. The network of claim 22, wherein
the UPnP enabling device is further configured to provide at least one of: a device description, a service description, a presentation page, an event, and a value of a variable corresponding to the device on the non-IP network, in response to a UPnP request from the UPnP controller.

24. The network of claim 23, further including
a file server on the IP sub-network, and
wherein
the UPnP enabling device provides the at least one of: the device description, the service description, the presentation page, the event, and the value of the variable, based on information received from the file server.

25. The network of claim 20, wherein
the UPnP enabling device facilitates the control of the device on the non-IP sub-network by a UPnP controller on the IP sub-network via the use of threads that provide a non-blocking communication.
